(19) United States
(12) Patent Application Publication
(10) Pub. No.: US 2003/0223227 A1
(43) Pub. Date: Dec. 4, 2003

(54) Smart pad switches

(75) Inventor: Stephen Levine, Far Hills, NJ (US)

Correspondence Address: DARBY & DARBY P.C., 805 Third Avenue, New York, NY, 10022, US

(73) Assignee: Team Products International, Inc.

(21) Appl. No.: 10/160,075

(22) Filed: May 29, 2002

(51) Int. Cl. F21L 13/00; F21L 4/04

(52) U.S. Cl. 362/183; 362/295; 362/202; 362/394; 362/399

(57) ABSTRACT

A switch pad used to operate a handheld spotlight has operating buttons which control different functions of the spotlight, including a 50% power switch, a map light switch, and a battery charge status switch. Each of the buttons may be reached by the thumb of the user while holding the spotlight. The charge status may be indicated by a series of LEDs on the switch pad. Further, the switch pad may include a DC power socket, which may be used to recharge a battery within a spotlight or may also b0e used as a power source.

### BACKGROUND OF THE INVENTION

The present invention relates to a switch pad for operating an electrical device. In a preferred embodiment, the switch pad is used to operate the various functions of a handheld spotlight. However the present invention can readily be used in other applications.

Electrical devices typically have at least one switch to control their operation, e.g. an on/off switch. As electrical devices incorporate multiple functions, the number of switches multiply to provide user control of those functions. One aspect of the field of Human Engineering is to locate switches at positions that make them easy for humans to operate and that make the manner of their operation instructive.

Handheld electrical devices provide a particular challenge to the positioning of control switches because the hand must be used to both hold the device and operate the switches without undue strain on the hand and without significant opportunity to operate the wrong switch.

In recent years there has been a proliferation of large handheld flashlights. See for example, U.S. Pat. No. D256,845. Those large flashlights generally have a large diameter cylinder that is held in the horizontal position during normal operation by a downwardly depending pistol grip. The cylinder structure holds a large battery at its rear portion and a high power lamp at its front portion. A trigger switch is provided on the pistol grip so that the large flashlight can be held by all of the hand of the user, except for the index finger. The index finger is then free to operate the trigger switch to turn the light on and off.

As additional functions have been added to large flashlights and other handheld devices, particularly those with pistol grips, a need has arisen for convenient, accurate and low stress positioning of controls for these additional functions.

### SUMMARY OF THE INVENTION

The present invention is directed to circuitry and a switch pad assembly used to control an electrical device, especially a handheld device. This control allows for operation by the index finger and thumb of the user. In an illustrative embodiment of the invention, an electrical device, e.g. a large flashlight with a pistol grip, has a trigger switch to turn the main light on. This trigger switch may be activated by the index finger of the user while the flashlight is held upright by the other three fingers and palm of the user's hand.

The flashlight also has a map light which is operated by a switch on a switch pad located on the rear of the flashlight. The switch on the switch pad can be operated by the thumb of the user while the flashlight is held by the palm of the user's hand and his fingers. Additional switches may be provided on the switch pad and operated alternately by the user's thumb. These other switches may, for example, reduce the power of the main light by 50% and activate a battery charge indicator. The battery charge indicator may be by way of a series of light emitting diodes.

The switches on the switch pad control an electronic circuit located on a printed circuit board mounted to the underside of a bezel at the rear of the flashlight. Operating buttons are used to activate the switches, and are mounted to pass through the switch pad and bezel to engage tops of the switches positioned on the printed circuit board. LEDs which are used to indicate battery status are also mounted on the printed circuit board and project outwardly through openings in the bezel and switch pad. The circuitry on the printed circuit board also includes a low power DC socket to allow the battery within the spotlight to be recharged or to serve as a power source to operate other devices. This socket is also mounted on the circuit board and extends through an opening in the bezel and switch pad.

In the preferred embodiment, one of the buttons of the switch pad is used to vary the power output of the spotlight between 50% and full power. A second button is used to illuminate a map light, but does not activate the main spotlight. A third button activates the battery charge status display, which is in the form of different color LEDs e.g. red, yellow and green. If the battery charge is weak, only the red LED illuminates. If it is marginal the red and yellow LED illuminate. When the battery is near full charge the red, yellow and green LEDs illuminate.

### DESCRIPTION OF THE DRAWINGS

The foregoing and other features of the present invention will be more readily apparent from the following description and drawings of illustrative embodiments of the invention in which:

FIG. 1 is a perspective view of a spotlight which is operated by a switch pad, in accordance with an embodiment of the invention;

FIG. 2 is a rear view of a switch pad, in accordance with the preferred embodiment of the invention;

FIG. 3 is a diagram of the circuit of the switch pad for use with a 12 volt battery, in accordance with the preferred embodiment of the invention; and

FIG. 4 is a diagram of the circuit of the switch pad for use with a 6 volt battery, in accordance with the preferred embodiment of the invention.

### DESCRIPTION OF THE PREFERRED EMBODIMENT

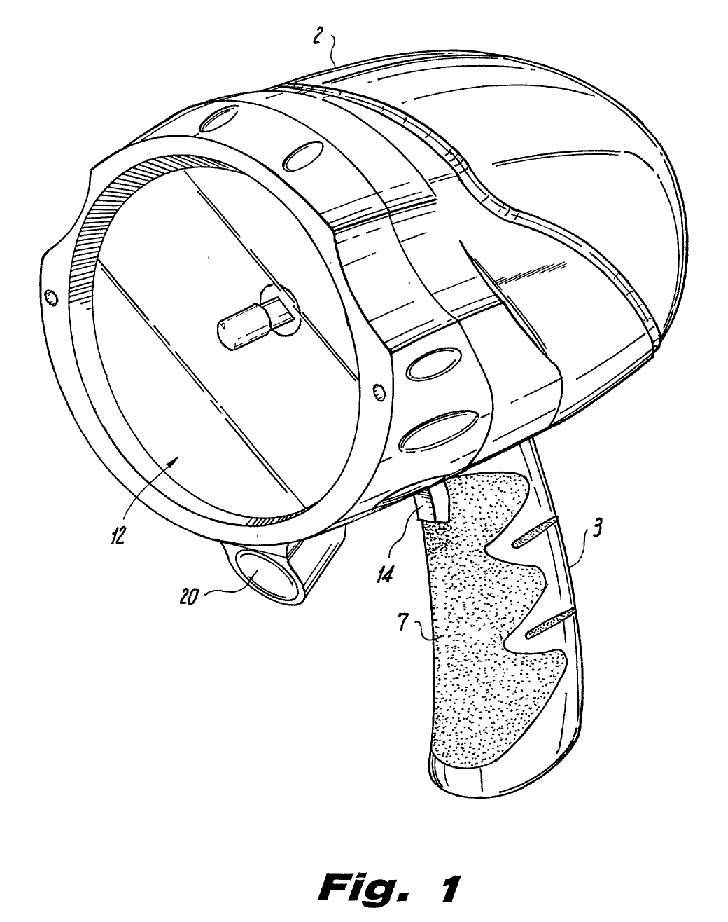

FIG. 1 shows a spotlight which may be operated by the switch pad of the invention. The switch pad may also be used in other electrical devices. The spotlight or flashlight of FIG. 1 has a pistol shape with a large, generally cylindrical portion 2 and a pistol grip 3 extending generally perpendicularly from the cylindrical portion. At the front end of the cylindrical portion there is a large or main lamp 12, which when appropriately powered may generate 500,000 candlepower or more. Just below the large lamp 12 is a small or map lamp 20, which may be separately operated.

The handle 3 has a trigger switch 14 at an upper front location so that it can be operated by the index finger of the user, while the palm of the user is placed against the back of the handle or grip 3 and the other fingers of the user's hand grip the front of the handle to hold the flashlight in a stable position. Further, the flashlight may have a pleasing ornamental design and gripping surfaces 7 on the handle.

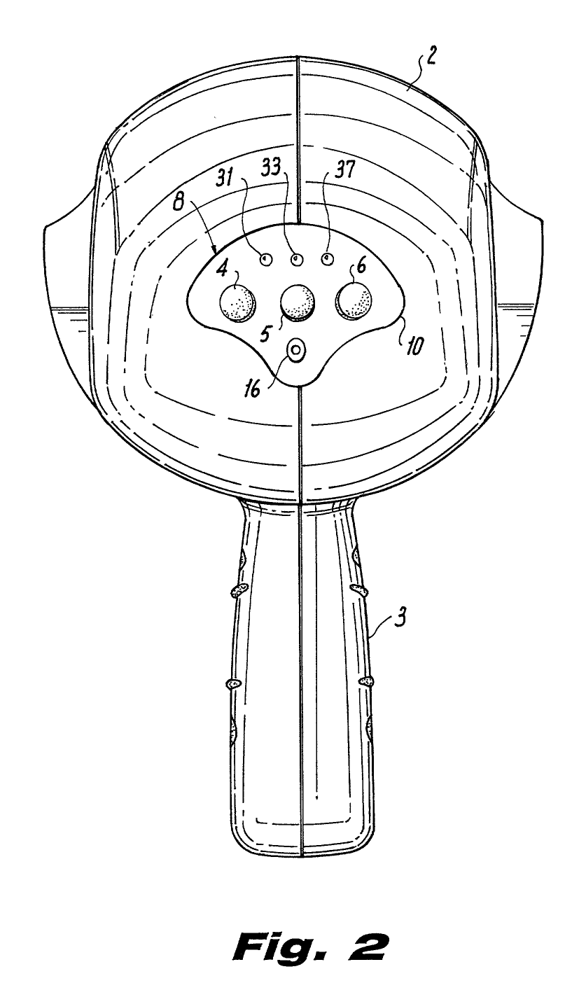

FIG. 2 shows the rear of the spotlight of FIG. 1. As can be seen, it includes a switch pad 8 comprising a bezel 9 containing a plurality of openings. LEDs 31, 33, 37 and buttons 4, 5, 6 are disposed in the openings of the bezel 9 and protrude outwardly. Each button controls a specific function of the spotlight. For example, button 4 may control the power output level of the main lamp, button 5 may activate the map light 20, and button 6 may control a battery charge status indicator formed from the LEDs 31, 31, 37. The switch pad 8 further comprises a low-level DC output socket 16. Socket 16 may be used to recharge a battery within the spotlight, and may also be used as a power output socket.

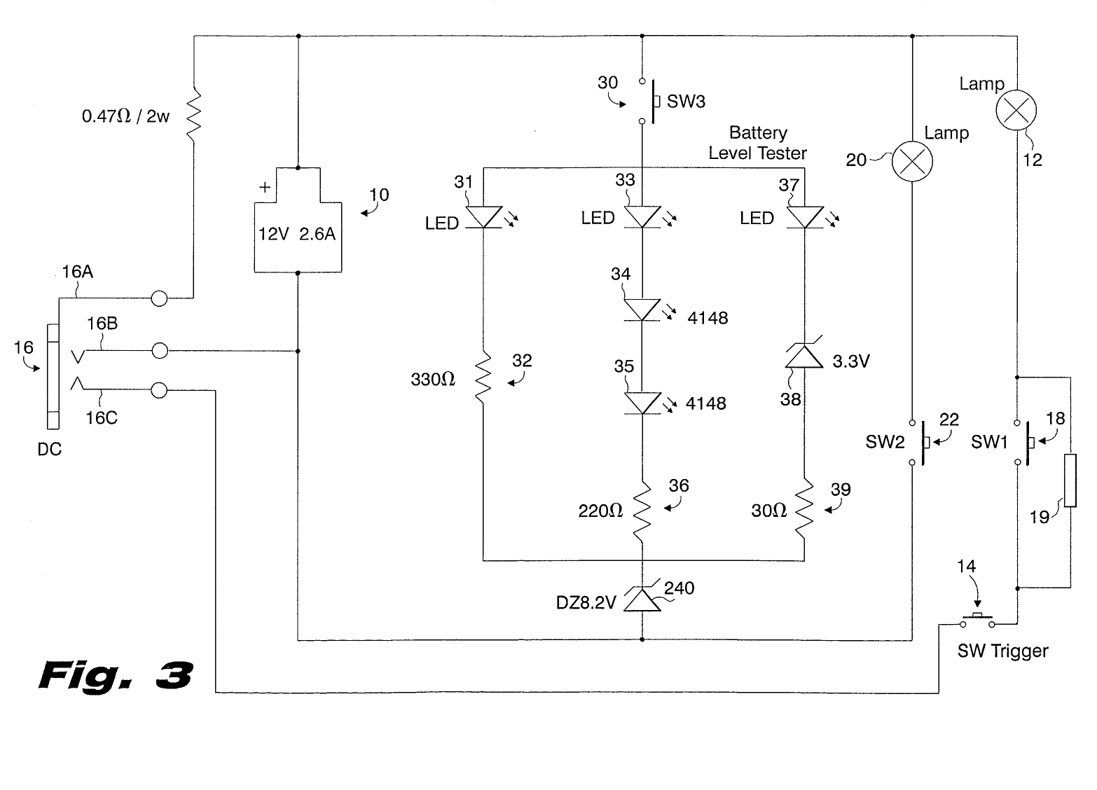

FIG. 3 shows an embodiment of a circuit for responding to the buttons when the flashlight uses a 12 volt battery. This circuit must be located on a printed circuit board within the housing of the flashlight, preferably adjacent the bezel. This circuitry provides the various functions in response to operation of the switch pad buttons.

In FIG. 3, a battery 10 is shown with its positive terminal connected to one terminal of the main lamp 12 of the spotlight. The opposite side of the main lamp 12 is connected through a normally closed switch 18 to the normally open trigger switch 14. The other side of trigger switch 14 goes through the normally closed contacts of DC output plug 16 to the negative side of battery 10. Thus when the trigger switch 14 or the spotlight is actuated, the full voltage from battery 10 is applied across lamp 12 and the maximum illumination is achieved.

When button 4 is pressed, it actuates the 50% power switch 18, which opens the short-circuit across a resistor 19, which has the effect of dropping the voltage applied to lamp 12 so that it is only 50% of its maximum value.

The map lamp 20 is illuminated by pressing button 5, which activates its switch 22 in substantially the same manner as the 50% power switch 18. In particular the positive output of battery 10 is applied to one input of map lamp 20. The other side of lamp 20 passes through switch 22 and returns to the negative side of the battery. Thus, when switch 22 is closed, the power is applied to the map lamp 20 causing it to illuminate.

The battery level tester is operated by pressing button 5, which closes switch 30. This applies the existing voltage of the battery to a network comprising light emitting diodes 31, 33 and 37 which are connected in parallel through other circuit elements to a zener diode 40. The effect of the zener diode is to lower the battery voltage which is applied to the circuit elements 31 through 39. LEDs 31, 33, and 37 communicate the battery charge status. LED 31 is in series with the resistor 32 while LED 33 is in series with voltage dropping diodes 34, 35 and resistor 36. LED 37 is in series with zener diode 38 and resistor 39. As a result of the elements, 32, 34-36, 38 and 39, different voltage levels are applied across LEDs 31, 33 and 37. These are all set so that if the battery is at a high voltage, for example 12 volts, all three LEDs will light. However, if the battery charge has been reduced over time, it will not be sufficient to cause LED 37 to light, while LEDs 31 and 33 will light. If the battery voltage is reduced even more, then only LED 31 will light. Finally, if the battery is near exhaustion, none of the LEDs will light.

Thus it can be seen that the Smart Pad allows the power output of the main lamp to be reduced by 50%, operates the map light and allows a battery test level indication by means of the LEDs 31, 33 and 37. This can all be accomplished using one hand, with the index finger operating the trigger switch 14 and the users thumb operating buttons 4, 5 and 6, all while holding the spotlight with the same hand.

If a plug is inserted into DC output socket 16, the outer edges of the plug may contact with terminal 16A in FIG. 3, which is connected to the positive side of the battery 10. The center prong of the plug will separate terminals 16B and 16C, but will continue to cause them to be connected together. These terminals represent the negative or ground side of the battery. Thus, the full voltage of the battery is applied from plug 16.

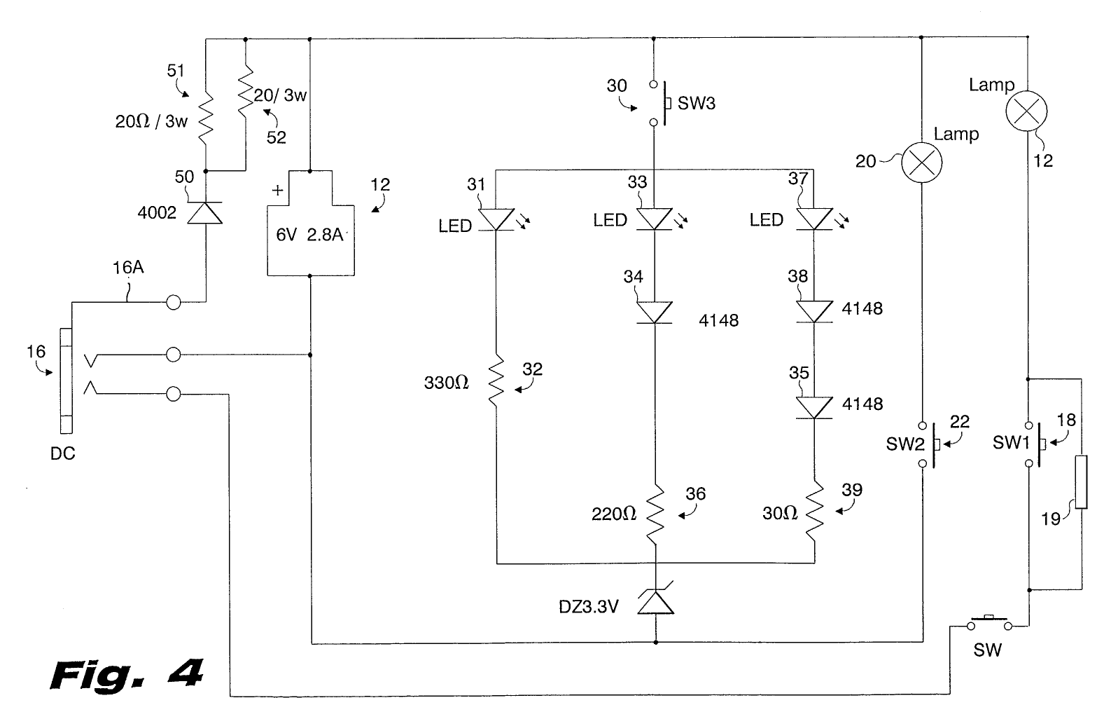

FIG. 4 is similar to FIG. 3, except that it handles the case where the battery has a 6 volt output. It works in substantially the same way as FIG. 3 and parts which are the same have been given the same reference number. One of the differences, however, is that diode 35, which is in series with LED 33 in FIG. 3 is moved so that it is in series with LED 37 in FIG. 4. This changes the voltage level breaks for the LEDs to compensate for the 6 volt battery.

In addition, plug 16 in FIG. 4 is actually a DC charging input port for the battery, assuming the battery is a rechargeable one. The exterior voltage is applied to the outer terminal 16A of plug 16 and the center of the plug attaches to ground as in FIG. 3. The input voltage then passes through a diode 50 which assures that the charge is applied in the correct direction. In addition, resistors 51 and 52, which are high wattage resistors, limit the amount of current that can be applied to the battery 10.

While the invention has been particularly shown and described with reference and preferred embodiments thereof, it will be understood by those skilled in the art that various changes in form and details may be made therein without departing from the spirit and scope of the invention.

We claim:

1. A switch pad for operating an electrical device having a pistol shape with a grip, comprising:
a switch pad located on the device such that the thumb of the user can reach it while the hand of the user holds the device by the grip, said switch pad having at least two buttons that may be operated by the thumb of the user to affect the operation of switches which control the device.

2. The switch pad of claim 1, further including indicator lights controlled by one of the buttons and indicating the status of the device.

3. The switch pad of claim 2 wherein the indicator lights are light emitting diodes.

4. The switch pad of claim 1 wherein the device is battery operated and the switch pad further includes a power output socket that makes available the power of the battery at the switch pad.

5. A flashlight with a pistol shape and having a pistol grip, comprising:
a portable power source;
a main light;
a trigger switch on the pistol grip which may be actuated by the index finger of the user;
a map light;
a switch pad with buttons that operate switches, said buttons being reachable by the thumb of the user when the user's hand is gripping the pistol grip;
and a circuit, wherein operation of the trigger switch causes the main light to turn on and operation of a button on the switch pad causes the map light to turn on.

6. The flashlight as claimed in claim 5 wherein operation of another button on the switch pad causes the intensity of the main light to decrease.

7. The flashlight as claimed in claim 6 wherein operation of the other button places a resistance in series with the power source and main light to decrease the intensity of the main light by about 50%.

8. The flashlight of claim 5 further including a plurality of light emitting diodes to indicate the status of the battery, and wherein the power source is a battery and the operation of a further button on the switch pad causes the circuit to direct power to the light emitting diodes such that the number of light emitting diodes that turn on is related to the charge on the battery.

9. The flashlight of claim 8 wherein there are three light emitting diodes to indicate the battery charge, each light is in series with one or more of at least a resistor and diode to form a series path and each of the series paths are in parallel with each other, so that different voltage levels are across each light emitting diode when the further button is operated, and wherein the voltage levels depend on the voltage of the battery.

10. The flashlight of claim 5 wherein there is a d.c. socket on the switch pad, said d.c. socket being connected across the power source to provide the voltage of the power source at the switch pad and to provide access to the power source for charging.
